(19) United States
(12) Patent Application Publication
(10) Pub. No.: US 2010/0134596 A1
(43) Pub. Date: Jun. 3, 2010

(54) APPARATUS AND METHOD FOR CAPTURING AN AREA IN 3D

(76) Inventor: Reinhard Becker, Ludwigsburg (DE)

Correspondence Address: CANTOR COLBURN, LLP, 20 Church Street, 22nd Floor, Hartford, CT, 06103, US

(21) Appl. No.: 12/515,034

(22) PCT Filed: Apr. 3, 2006
(86) PCT No.: PCT/EP06/03010

§ 371 Date: May 15, 2009

(30) Foreign Application Priority Data
Mar. 31, 2006 (DE) 20 2006 005 643.2

(51) Int. Cl. H04N 13/02

(52) U.S. Cl. 348/47; 348/E13.015

(57) ABSTRACT

An apparatus for three-dimensional coverage of a spatial area has a rangefinder for finding the range to an object point in the spatial area, and has an image recording unit. The rangefinder contains a transmitter for transmission of a transmitted signal which is largely in the form of a beam to the object point, a receiver for receiving a reflected signal from the object point, and an evaluation and control unit which is designed to determine the range to the object point on the basis of the transmitted signal and the reflected signal. The apparatus furthermore contains a beam scanning unit which is designed to point the transmitted signal in different spatial directions. The image recording unit has a defined image recording area, and is coupled to the beam scanning unit in order to align the image recording area and the transmitted signal with the same object point.

The present invention relates to an apparatus for capturing an area in 3D, with a distance meter for determining a distance from an object point in said area, said distance meter possessing an emitter for emitting a widely beam-shaped emitted signal to the object point, a receiver for receiving a signal reflected from the object point and an evaluation and control unit that is configured to determine, from the emitted signal and from the reflected signal, the distance to the object point and with a beam sweeper that is configured to orient the emitted signal in different directions in space.

The invention further relates to a method for capturing an area in 3D, involving the following steps: emitting a widely beam-shaped emitted signal to an object point in the area, receiving a signal reflected from the object point and determining a distance to the object point from the emitted signal and from the reflected signal and orienting the emitted signal in different directions in space with the help of a beam sweeper.

Such an apparatus and such a method are known from DE 202 08 077 U1.

The known apparatus uses a laser beam that is deviated in different directions in space with the help of a rotating mirror. The mirror rotates about a horizontal axis of rotation and is inclined at an angle of about 45° with respect of the axis of rotation for the laser beam to scan a vertical area. In addition thereto, the metering head is rotated about a vertical axis together with the emitter, the receiver and the rotary mirror. As a result, the known device is capable of almost completely scanning an area. The laser beam is only limited toward the bottom by the housing of the metering head and/or by the base on which it stances.

With the known device, a three-dimensional distance image of a volume or of an area can be captured. Preferred applications for such an apparatus are for example the surveying of tunnel sections, buildings, monuments or also the guidance of driverless transport systems. Thanks to the distance data obtained, dimensions inside the volume or area can also be determined later on from the registered data. The mere distance data are however disadvantageous for acquiring a visual impression of the captured area. For this purpose, the known apparatus also determines values of the intensity of the reflected signal, these serving to generate intensity images that are approximately comparable to a black and white image of the volume or the area. Although a good visual impression of a captured area can thus already be obtained, it is desired to even further improve the three-dimensional capturing and reproduction for making it more true to life.

In view thereof, it is an object of the present invention to further develop an apparatus and a method of the type mentioned herein above in order to generate an even more realistic and true-to-life impression of an area captured in 3D.

In accordance with one aspect of the present invention, the solution to this object is achieved with the help of an image capturing unit for recording an image of the area, said image capturing unit having a defined image capturing region (viewing region) and said image capturing unit being coupled to a beam sweeper in order to orient the image capturing region and the emitted signal onto the same object point.

According to still another aspect of the invention, the solutions to these objects are achieved by a method of the type mentioned herein above, wherein an image of the area is recorded with an image capturing unit, said image capturing unit having a defined image capturing region and said image capturing unit being coupled to the beam sweeper in order to orient the image capturing region and the emitted signal onto a plurality of identical object points.

Accordingly, the present invention combines an apparatus and a method of the type described herein above with an image capturing unit or “camera” with the help of which a “normal” photograph of the area can be made. Preferably, it is a digital image capturing unit so that the image data are in digital form and can be stored together with the distance data, which typically are also digital.

In accordance with the invention, the picture capturing unit is coupled to the beam sweeper in such a manner that the area captured by the image capturing unit can be accurately associated with the distance data. As a result, the distance data of the distance meter can be brought to coincide in a very simple and accurate manner with the purely visual image data of the image capturing unit. Through this combination, one obtains a very true-to-life image quality of the recorded area as one is used to obtaining it from a photograph. The quality of such an image is higher than the optical impression that can be derived from the intensity image of the distance meter. In addition to the high-quality optical image, the novel apparatus also provides the distance data to the object points, thus offering all the advantages and possibilities of utilization of the known apparatus.

By virtue of the high image quality the novel apparatus offers with the help of the image capturing unit, optical details of the area can be better recognized and evaluated. This opens novel possibilities of application such as a three-dimensional capture of the scene of an accident or of a crime for documentation of police investigation.

Generally, the novel apparatus offers a low-cost possibility to capture in 3D a highly detailed image of an area and to deliver a true-to-life reproduction thereof. Accordingly, the solution to the object mentioned above is fully achieved.

In a preferred embodiment, the image capturing unit is configured to record an optical image of the area in color.

With this embodiment the area can be captured in an even higher true-to-life quality. Discrete details inside the area can be evaluated even more accurately with the acquired image data.

In another embodiment, the image capturing unit is configured to record a thermal image of the area or also an image of the area in other wavelength ranges.

In this embodiment, the image capturing unit is in particular capable of recording an infrared image of the area. As a result, other properties of the area can be acquired and documented for subsequent evaluation. The range of utilization of the novel apparatus is even advantageously widened.

In another embodiment, the evaluation and control unit is configured to determine a gray-scale image of the area using signal amplitudes of the reflected signal.

Taken alone, this embodiment is already realized on the known device. In combination with the present invention, it offers the particular advantage that the image data captured with the image capturing unit can be compared with the “image data” of the distance meter in order to obtain further inferences about the properties of the acquired area. In comparing an optical image in color with the gray-scale image of the distance meter, one can in particular draw inferences with respect to the reflection properties and, as a result thereof, inferences with respect to the material properties of objects in the area.

In another preferred embodiment, the evaluation and control unit is further configured to accurately (and preferably completely, i.e., for each measured point of the distance meter) superimpose the gray-scale image and the image of the image capturing unit.

With this embodiment, the optical image of the area captured with the image capturing unit can be associated very simply and accurately with the distance data determined with the distance meter. This embodiment makes it in particular possible to “colorize” the gray-scale image in which each image point is allocated a distance data with the optical image of the image capturing unit in order to obtain for each object point a very true-to-life image with additional distance data.

In another embodiment, the beam sweeper comprises a first rotary drive for rotating the beam-shaped emitted signal about a first, preferably vertical, axis of rotation.

This embodiment makes it easier to record a panoramic image or allround image of the area with the help of the novel image capturing unit. As a result, this embodiment allows for a very simple acquisition of the area over a 360° azimuth angle.

In another embodiment, the image capturing unit comprises an image sensor with a plurality of aligned side-by-side picture elements (pixels) forming a line of picture elements, said line of picture elements being adapted to be positioned parallel to the first axis of rotation.

This embodiment includes embodiments with an image sensor comprising a plurality of picture elements in a matrix-like arrangement insofar as the picture elements of one line or column of picture elements, which is, or can be, positioned parallel to the first axis of rotation can be read specifically. The embodiment is advantageous since the optical image is captured by scanning upon rotation of the image capturing unit about the first axis of rotation, which corresponds to the way the distance meter works. As a result, the optical image data and the distance data can be associated more easily and more accurately. Irrespective thereof, this embodiment includes embodiments in which the image capturing unit is disposed in a fixed position with respect to the distance meter on the one side and also embodiments in which the image capturing unit is pivotal or otherwise variable with respect to the distance meter. Accordingly, the line of picture elements can be permanently parallel to the first axis of rotation or it is only pivoted into such an orientation to capture the image.

In another preferred embodiment the image sensor is a line sensor.

Line sensors in the sense of this embodiment are image sensors provided with only a small number of lines or columns with picture elements for capturing an image data. A preferred line sensor for a monochrome captured image (black and white) only has one single line or column of picture elements. A particularly preferred line sensor for capturing a color image of the area, by contrast, has three parallel lines of picture elements, there being provided one first line of picture elements for capturing a first color component (e.g., red), one second line of picture elements for capturing a second color component (e.g., green) and one third line of picture elements for capturing a third color component (e.g., blue). These embodiments allow for a particularly low-cost implementation.

Moreover, the image data of the image capturing unit in this embodiment can be read and associated very simply and fast quickly the distance data of the distance meter. Further, this embodiment contributes to reduce the size of the image files without loss of image quality.

In another embodiment, the image sensor has several parallel lines of picture elements for capturing different color components, the parallel lines of picture elements being arranged in a defined spaced-apart relationship and the first rotary drive rotating at a speed that is or will be adapted to the defined spacing so that each of the parallel lines of picture elements captures the same object points.

This embodiment is particularly advantageous in connection with an image sensor having three parallel lines of picture elements for capturing three different color components or line images of different color, in particular for capturing one red, one green and one blue line image of the area. With the adapted speed at which the first rotary drive rotates, one achieves that the three color images can be superimposed very simply and above all accurately in order to thus obtain a “varicolored” image of the area. In this embodiment, it is particularly preferred that the speed at which the first rotary drive rotates can be set as a function of the distance between the lines of picture elements, of the existing or set line resolution during image capture and/or as a function of the exposure time needed for capturing one single line, because in this embodiment the best image quality is achieved as a function of the surrounding situation.

In another embodiment, the beam sweeper comprises a second rotary drive for rotating the emitted signal about a second, preferably horizontal, axis of rotation.

This embodiment allows for an almost complete acquisition of an area in azimuth and in elevation in a very simple manner.

In another embodiment, the line of picture elements can be positioned at right angles to the second axis of rotation.

This embodiment is advantageous because the serially read picture elements can be very readily associated with the object points, which are scanned with an emitted signal rotated about the second axis of rotation.

In still another embodiment, the first and the second axis of rotation define a point of intersection of the axes and the image capturing unit has an optical axis that can be positioned, at least optionally, in the region of the point of intersection of the axes. Preferably, the image capturing unit can be positioned for its optical axis to pass through the point of intersection of the axes of the two axes of rotation.

With this embodiment, a parallax between the viewing angle of the image capturing unit and the viewing angle of the distance meter is reduced or even minimized. As a result, this embodiment makes it possible to associate the distance data and the image data in an even more simple and accurate way. Parallax errors can be better avoided.

In another embodiment, the apparatus includes one height-adjustable stand with a height scaling for exact positioning of the image capturing unit.

In practical implementation, combining the image capturing unit with the distance meter is difficult because the image capturing unit can impair the viewshed of the distance meter. This applies in particular if the optical axis of the image capturing unit is to be brought into the region of the point of intersection of the axes. The preferred embodiment makes it possible to dispose the image capturing unit above or beneath the point of intersection of the axes. With the help of the height scaling, the difference can be equalized by capturing at first, in a first run, the distance image without image capturing unit and by then, in a second run, recording the optical image, the stand (e.g., a tripod or a height-adjustable column) between the two runs being lowered or raised as far as needed for the image capturing unit to enter the point of intersection of the axes of rotation of the first run. The embodiment is a very simple and low-cost possibility of combining the image capturing unit and the distance meter in one apparatus.

In another embodiment, the beam sweeper includes a rotary mirror configured to divert the emitted signal into different directions, the image capturing unit being at least optionally adapted to be positioned in the region of the rotary mirror.

This embodiment is a particularly elegant possibility to integrate an image capturing unit into an apparatus of the type described herein above. Since the image capturing unit can be positioned in the region of the rotary mirror, parallax errors can be reduced to a minimum in a very simple way.

In another embodiment, the apparatus has a housing structure with at least two separate housing parts and it also has a holding device for the image capturing unit, which is removably connected to the at least one housing part.

This embodiment makes it possible to operate the novel apparatus either with or without image capturing unit so that the use of the image capturing unit is optional. Moreover, with this embodiment, prior apparatus can be very readily retrofitted with the novel image capturing unit.

In another embodiment, the holding device comprises a pivotal arm on which the image capturing unit is, preferably also removably, disposed.

In exemplary practical implementations this embodiment has proved to be a very simple and robust possibility allowing for both ease of handling and high accuracy in superimposition and association of image data and distance data.

In another embodiment, the holding device comprises an approximately U-shaped clamp for mounting the holding device onto the at least one housing part.

This embodiment has proved to be a very simple and advantageous solution to retrofit existing apparatus with the novel image capturing unit.

In another embodiment, the image capturing unit is pivotal into a plane located between the at least two housing parts with the help of the holding device. Preferably, the axis of rotation of the first rotary drive also extends in this plane so that the image sensor can be positioned together with the holding device so as to coincide with the axis of rotation.

This embodiment has the advantage that on the one side the image capturing unit can be brought very close to the center of the novel apparatus, said center usually defining the coordinate origin for the distance meter. On the other hand, the image capturing unit can be simply pivoted out of this region, so that the distance meter is given a considerably free sight onto the object points of the area. This embodiment therefore combines a quite simple, low-cost and robust assembly with the possibility to place the image capturing unit almost optimally in the center of the novel apparatus.

It is understood that the above mentioned features and those discussed herein after may not only be used in the combinations mentioned but may also be used alone or in any combination with each other within the scope of the present invention.

Exemplary embodiments of the invention are shown in the drawing and will be discussed in the following description. In said drawing:

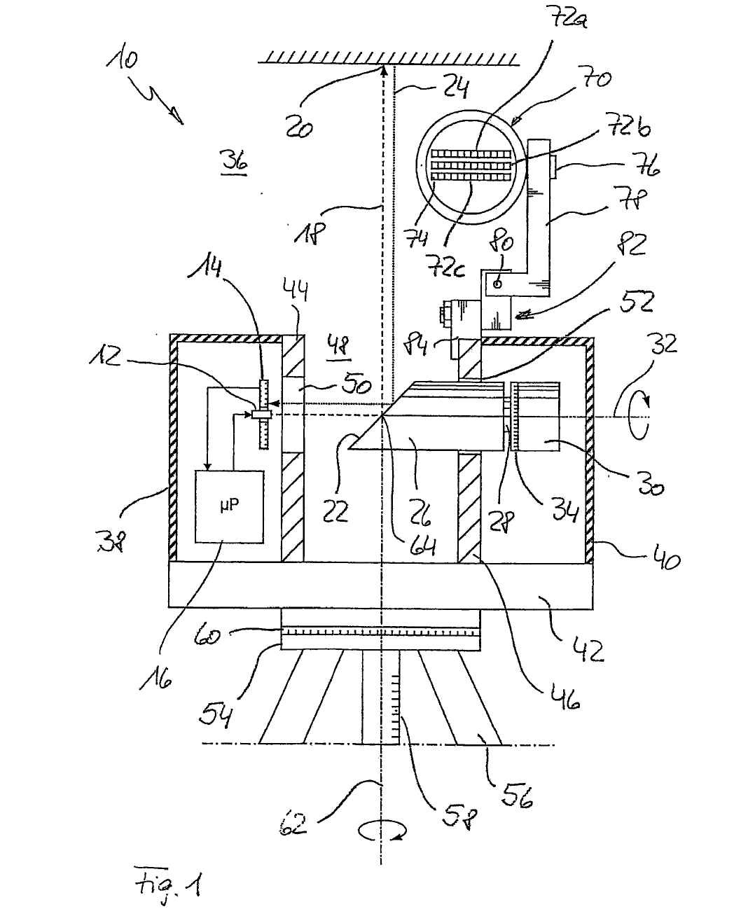

FIG. 1 shows a preferred exemplary embodiment of the novel apparatus in a simplified, partial section view,

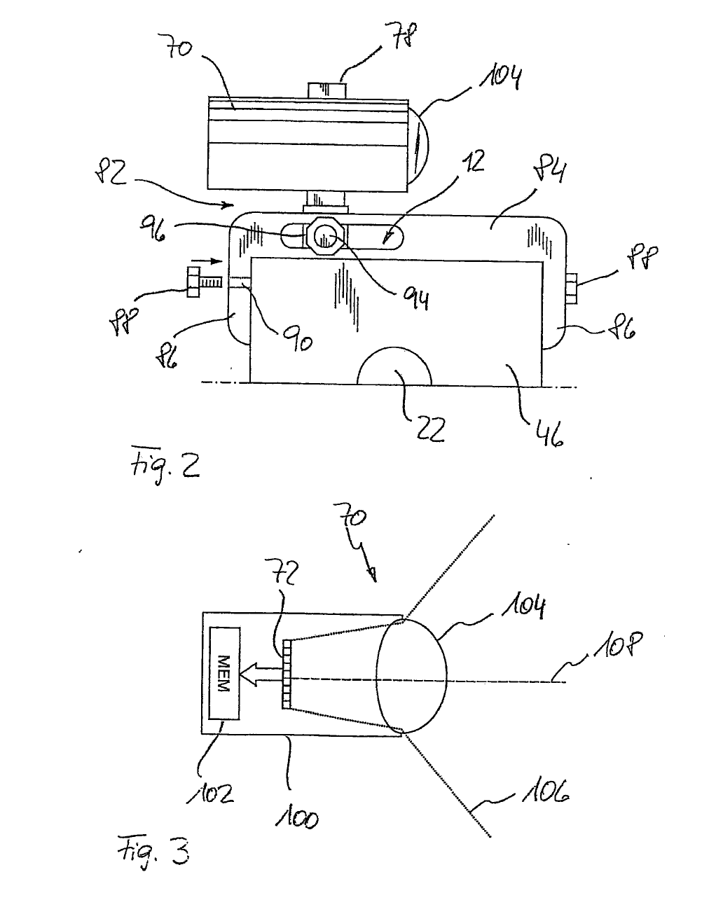

FIG. 2 is a detail view of the apparatus shown in FIG. 1, with the image capturing unit being fastened to a housing part of the apparatus via a holding device,

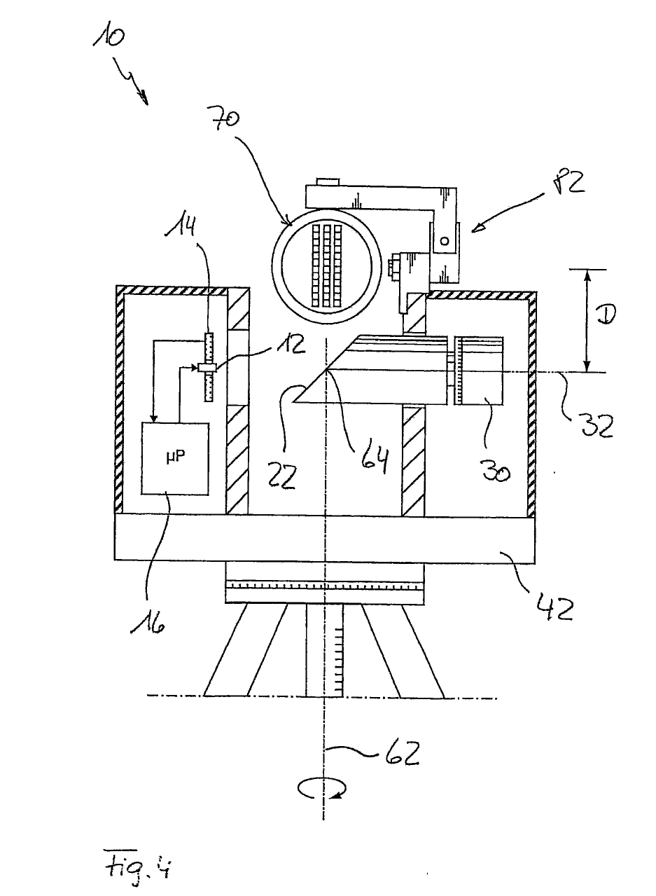

FIG. 3 is a simplified, schematic illustration of the novel image capturing unit, and

FIG. 4 shows the apparatus shown in FIG. 1 in a second position of operation.

In the FIGS. 1 through 4, a preferred exemplary embodiment of the novel apparatus is indicated in its entirety with the reference number 10.

The apparatus 10 includes an emitter 12 and a receiver 14, which are both connected to an evaluation and control unit 16. In the preferred exemplary embodiment, the emitter 12 includes a laser diode that is configured to emit a laser beam 18 in order to illuminate an object point 20 in the area. Typically, the laser beam 18 is modulated. The invention is not limited to such types of distance meters, though. The emitted signal could also be an ultrasound signal or another optical or electromagnetic signal.

In this exemplary embodiment, the laser beam 18 is diverted to the object point 20 via a mirror 22. A reflected beam labeled with the reference number 24 is reflected from the object point 20 and is diverted to the receiver 14 via the mirror 22. The evaluation and control unit 16 is capable of determining the distance between the apparatus 10 and the object point 20 from the travel time of the emitted laser beam 18 and of the received reflected beam 24. For this purpose, the time difference between the two signals is evaluated using phasing and/or pulses. Accordingly, the emitter 12, the receiver 14 and the evaluation and control unit 16 form a distance meter.

The mirror 22 is here formed on the front end face of a cylinder 26 that is connected to a rotary drive 30 via a shaft 28. With the help of the rotary drive 30, the mirror 22 can be rotated about an axis of rotation 32. The respective position of rotation of the mirror can be determined with the help of an encoder 34. The output signals of the encoder 34 are also supplied to the evaluation and control unit 16 (not shown herein for the sake of clarity).

In the preferred exemplary embodiment, the axis of rotation 32 is disposed horizontally and the mirror 22 is inclined at an angle of about 45° with respect to the axis of rotation 32. Accordingly, rotation of the mirror 22 about the horizontal axis 32 results in the fact that the laser beam 18 is diverted along a vertical plane that is perpendicular to the axis of rotation 32. The laser beam 18 forms like a fan by means of which the area 36 is scanned in a vertical plane.

In this exemplary embodiment, the apparatus 10 has a housing structure that substantially comprises two housing parts 38, 40 which are disposed on one common base plate 42. The housing part 38 on the left in FIG. 1 accommodates the emitter 12, the receiver 14 and the evaluation and control unit 16. The housing part 40 on the right in FIG. 1 houses the rotary drive 30 with the encoder 34 and with the cylinder 26, said cylinder projecting from the housing part 40 together with the mirror 22 so that the mirror 22 is arranged approximately in the center between the two housing parts 38, 40. In the preferred exemplary embodiment, the two housing parts 38, 40 each have one reinforced side wall 44 and 46 respectively, which face each other in parallel alignment and which define the intermediate space 48 between the housing parts 38, 40. The side wall 44 has an opening 50 through which the laser beam 18 can exit the housing part 38 and the reflected beam 24 can enter the housing part 38. In preferred exemplary embodiments, the opening 50 is closed with a window in order to prevent dirt from penetrating into the housing part 38.

The housing wall 46 has an opening 52 through which the cylinder 26 projects into the intermediate space 48. In the exemplary embodiments of the invention, the side walls 44, 46 form the weight-bearing parts of the housing structure, which are solidly connected to the base plate 42, whilst the housing parts 38, 40 can be removed from the base plate 42 or from the side walls 44, 46.

The base plate 42 is disposed on a rotary drive 54, which in turn is seated on a stand 56. Said stand 56 is adjustable in height and has a scaling 58 for accurate and reproducible height adjustment. An encoder labeled with the reference number 60 serves to determine the position of rotation of the rotary drive 54. The output signals of the encoder 60 are also supplied to the evaluation and control unit 16 (not shown herein).

The rotary drive 54 allows for rotation of the apparatus 10 about a vertical axis of rotation 62, which defines, together with the axis of rotation 32, a point of intersection of the axes 64. The point of intersection of the axes 64 lies approximately in the center of the mirror 22 and defines in preferred exemplary embodiments of the invention the origin of a system of coordinates to which all the measured distance values of the distance meter are related. In the preferred exemplary embodiment, the point of intersection of the axes 64 lies approximately in the center of the space 48 intermediate the side walls 44, 46.

With the help of the rotary drive 54, the “scanning fan”, which is generated with the help of the rotary drive 30, can be rotated up to 360° in azimuth. As a result, the laser beam 18 can illuminate almost any object point 20 in the surroundings of the apparatus 10. Shading occurs only toward the bottom because of the base plate 42 so that the viewing angle of the distance meter is limited downward to about 70° with respect to the vertical.

An image capturing unit is indicated with the reference number 70 and has in this exemplary embodiment a line sensor 72 with a plurality of picture elements 74 arranged side by side in a line. In the preferred exemplary embodiment, the line sensor 72 has three lines of picture elements 72a, 72b, 72c, which are arranged in a parallel side-by-side spaced-apart relationship, the spacing corresponding approximately to the width of three to ten picture elements 74 (not shown true to scale herein). Over each line of picture elements 72a, 72b, 72c there is disposed another color filter (not shown herein) so that the lines of picture elements 72a, 72b, 72c capture line images of different colors, which together build a RGB colour line image. Further details of the image capturing unit 70 are described herein after with reference to FIG. 3.

The image capturing unit 70 is removably fastened to a pivotal arm 78 through a pin 76. The pivotal arm 78 is configured in an L shape, the image capturing unit 70 being disposed on a first leg of the pivotal arm 78. The second leg of the pivotal arm 78 is pivotally carried on a holding device 82 by means of a pin 80. FIG. 1 shows the image capturing unit 70 in a first pivoted position of the pivotal arm 78. FIG. 4 shows the image capturing unit 70 in a second pivoted position, wherein the image capturing unit 70 projecting at least partially into the intermediate space 48 between the side walls 44, 46.

FIG. 2 shows the holding device 82 with the image capturing unit 70 in a side view of the side wall 46. As can be seen, the holding device 82 includes an approximately U-shaped clamp 84 that is pushed from the top onto the side wall 46. The lateral legs 86 of the clamp 84 form a surrounding grip about the upper region of the side wall 46. They are fixed with the help of clamp screws 88 that engage into corresponding holes 90 on the clamp 84 and—in preferred exemplary embodiments—into the side wall 46. By loosening the screws 88, the clamp 84 can be pulled upward and removed from the side wall 46 so that the entire holding device 82 can be separated, together with the image capturing unit 70, from the remaining apparatus 10.

The clamp 84 has a slot 92 through which a pin 94 projects, which is connected to the pivotal arm 78 via an intermediate part 96. The pin 94 is fixed to the clamp 84 through a nut.

Here, the image capturing unit 70 has a tube 100 in which there is disposed the line sensor 72. The tube 100 also accommodates a memory 102 for intermediate storage of the image data of the line sensor 72. The memory 102 is connected to the evaluation and control unit 16 (not shown herein).

In this exemplary embodiment, the image capturing unit 70 has an optical system with a so-called fisheye objective 104 that allows for a very wide image capturing range 106. In a preferred exemplary embodiment, the image capturing range 106 ranges from about −70° to about +70° related to the optical axis 108 of the image capturing unit 70. In the preferred exemplary embodiment, the line sensor 72 has a resolution of about 5000 pixels.

FIG. 1 shows the image capturing unit 70 in a pivoted position allowing for a disturbance-free distance measurement with the apparatus 10 in a first data acquisition run. In this first run, the mirror 22 is rotated about the axis of rotation 32, whilst the apparatus 10 is rotated about the vertical axis 62. Simultaneously, the emitter 12 emits the modulated laser beam 18 which scans the area 36 surrounding the apparatus 10 by virtue of the two movements of rotation. With the help of the reflected beam 24 and the angular positions of the rotary drives 30, 54, which are determined with the encoders 34, 60, the evaluation and control unit 16 determines for each object point 20 the distance related to the point of intersection of the axes 64. Moreover, the evaluation and control unit 16 evaluates the amplitude of the reflected beams 24 for each object point 20 in order to generate an image of the intensity or a gray-scale image of the area 36.

After the apparatus 10 has acquired the area 36 of concern with the help of the distance meter 12, 14, 16, the emitter 12 is switched off. The image capturing unit 70 is brought into the position shown in FIG. 4 with the help of the holding device 82. As shown therein, the holding device 82 is configured so that in this position the line sensor 72 is positioned parallel to the axis of rotation 62 and approximately in the center thereof so as to coincide with it. The optical axis 108 is then oriented with the axis of rotation 62, which it intersects however at a right angle. Here, the image capturing unit 70 is seated somewhat higher than was the point of intersection of the axes 64 when the distance values were acquired. Accordingly, in the preferred exemplary embodiments, the entire apparatus 10 is moved downward with the help of the stand 56 by the distance D, which corresponds approximately to the vertical distance separating the optical axis 108 from the point of intersection of the axes 64. Next, the apparatus 10 is caused to move circumferentially a second time with the help of the rotary drive 54, the image capturing unit 70 scanning and capturing the surrounding area 36 line by line. The image data from the line sensor 72 are stored temporarily in the buffer 102 and supplied to the evaluation and control unit 16. Then, the evaluation and control unit 16 can superimpose accurately and above all with respect to all the pixels (completely) the data of the distance meter and the image data of the image capturing unit 70 because parallax errors between the distance meter and the image capturing unit are avoided. In particularly preferred exemplary embodiments of the invention, the evaluation and control unit 16 is configured to automatically superimpose the gray-scale image of the distance meter and the image captured line by line by the image capturing unit, the data of the encoder 34, 60 being used. Preferably, the position of the image capturing unit 70 is calibrated before for this purpose, using a defined test image.

Alternatively, the image data and the data of the distance meter are superimposed and associated by accurately superimposing the image data and the gray-scale image of the distance meter—at need reworking the result by hand.

In preferred exemplary embodiments of the invention, the evaluation and control unit 16 is a personal computer that is housed in the housing part 38 of the apparatus 10. Alternatively, the housing part 38 can also include a pre-stage of the evaluation and control unit 16 for substantially performing digital signal processing. The image data and the data of the distance meter can then be evaluated and above all superimposed or brought together in an external PC (not shown herein) the advantage thereof being that an external PC can have a higher computing efficiency in view of the limited space available in the apparatus 10.

The rotary drive 54 is capable of rotating the image capturing unit at different rotational speeds. In a preferred embodiment, the rotary drive 54 is coupled to the evaluation and control unit 16 (not shown herein), which controls the rotational speed of the drive 54. In a preferred exemplary embodiment, the evaluation and control unit 16 at first controls a first image capture revolution in order to determine the ambient luminosity. As a function thereof, the evaluation and control unit 16 sets the exposure time and/or the diaphragm of the connected image capturing unit 70. Further, the evaluation and control unit 16 determines the best possible rotational speed of the rotary drive 54 as a function of the exposure time/diaphragm and of the set line resolution (e.g., 3600 line images for a 360° revolution). The rotational speed is set so that the parallel line sensors 72a, 72b, 72c each capture exactly the same object points in spite of their being laterally offset with respect to each other so that for each object point there are provided three color components which together yield an RGB color line image. Accordingly, the time interval between the three picture element lines is balanced by the movement of rotation of the image capturing unit 70.

1. An apparatus for capturing an area in 3D, the apparatus comprising:
a distance meter structured to determine a distance from an object point in said area, said distance meter comprising an emitter for emitting a widely beam-shaped emitted signal to said object point;
a receiver structured to receive a signal reflected from said object point;
an evaluation and control unit configured to determine, from said emitted signal and from said reflected signal, the distance to said object point and with a beam sweeper that is configured to orient said emitted signal in different directions in space;
an image capturing unit structured to record an image of the area, said image capturing unit having a defined image capturing region and said image capturing unit being coupled to the beam sweeper in order to orient said image capturing region and said emitted signal onto the same object point.

2. The apparatus as set forth in claim 1, wherein the image capturing unit is configured to record an optical color image of the area.

3. The apparatus as set forth in claim 1, wherein the image capturing unit is configured to record a thermal image of the area.

4. The apparatus as set forth in claim 1, wherein the evaluation and control unit is further configured to determine a gray-scale image of the area by means of signal amplitudes of the reflected signal.

5. The apparatus as set forth in claim 4, wherein the evaluation and control unit is further configured to accurately superimpose the gray-scale image and the image of the image capturing unit.

6. The apparatus as set forth in claim 1, wherein the beam sweeper comprises a first rotary drive in order to rotate the beam-shaped emitted signal about a first, preferably vertical, axis of rotation.

7. The apparatus as set forth in claim 6, wherein the image capturing unit comprises an image sensor with a plurality of picture elements arranged side by side in a line and forming a line of picture elements, said line of picture elements being adapted to be positioned parallel to the first axis of rotation.

8. The apparatus as set forth in claim 7, wherein the image sensor is a line sensor.

9. The apparatus as set forth in claim 7, wherein the image sensor has several parallel lines of picture elements for receiving different color components, said parallel lines of picture elements being disposed in a defined spaced-apart relationship and the first rotary drive having a rotational speed that is adapted to said defined spacing for each of the parallel lines of picture elements to capture the same object point.

10. The apparatus as set forth in claim 7, wherein the beam sweeper comprises a second rotary drive for rotating the emitted signal about a second, preferably horizontal, axis of rotation.

11. The apparatus as set forth in claim 10, wherein the line of picture elements can be positioned at right angles to the second axis of rotation.

12. The apparatus as set forth in claim 6, wherein the first and the second axis of rotation define a point of intersection of the axes and that the image capturing unit has an optical axis that can be positioned at least optionally in the region of the point of intersection of the axes.

13. The apparatus as set forth in claim 1, further comprising a height-adjustable stand with a height scaling for accurately positioning the image capturing unit.

14. The apparatus as set forth in claim 1, wherein the beam sweeper includes a rotary mirror that is configured to divert the emitted signal in different directions in space, said image capturing unit being adapted to be positioned optionally in the region of the rotary mirror.

15. The apparatus as set forth in claim 1, further comprising a housing structure with at least two separate housing parts and by a holding device for the image capturing unit that is removably connected to at least one housing part.

16. The apparatus as set forth in claim 15, wherein the holding device comprises a pivotal arm on which the image capturing unit is disposed.

17. The apparatus as set forth in claim 15, wherein the holding device comprises an approximately U-shaped clamp for placing said holding device onto the at least one housing part.

18. The apparatus as set forth in claim 15, wherein the image capturing unit is pivotal in a plane located between the at least two housing parts with the help of the holding device.

19. A method of capturing in 3D an area, the method comprising:
emitting a widely beam-shaped emitted signal to an object point in the area,
receiving a signal reflected from said object point and determining a distance to said object point by means of the emitted signal and of the reflected signal,
orienting the emitted signal in different directions in space with the help of a beam sweeper,
wherein an image of the area is moreover recorded using an image capturing unit, said image capturing unit having a defined image capturing region and said image capturing unit being coupled to the beam sweeper in order to orient the image capturing region and the emitted signal onto a plurality of identical object points.
